(19) United States
(12) Patent Application Publication
(10) Pub. No.: US 2014/0344695 A1
(43) Pub. Date: Nov. 20, 2014

(54) INVITATION TO PARTICIPATE BASED ON USER GENERATED CONTENT

(71) Applicant: FUNTINI, INC., Seattle, WA (US)

(72) Inventors: Joseph S. Lawandus, Bainbridge Island, WA (US); Andrew J. Wright, Seattle, WA (US); Shane John Small, Seattle, WA (US)

(73) Assignee: FUNTINI, INC., Seattle, WA (US)

(21) Appl. No.: 14/066,515

(22) Filed: Oct. 29, 2013

Related U.S. Application Data
(60) Provisional application No. 61/824,808, filed on May 17, 2013.

(51) Int. Cl. H04L 29/06; G06F 3/0484

(52) U.S. Cl. CPC H04L 65/403; G06F 3/0484
USPC 715/719; 709/204

(57) ABSTRACT

A computing device forms an electronic communication link with a first computing server. Video clips received from the first computing server are presented via a user interface of the first computing device. Each video clip includes information associated with a user who generated the video clip. A user of the computing device provides input identifying one of the video clips. Communication of an electronic invitation directed to the user who generated the selected video clip us requested. The electronic invitation invites the user who generated the selected video clip to participate in an interactive relationship via the first computing server. An indication that the electronic invitation was accepted by the user who generated the selected video clip is received at the computing device.

### BACKGROUND

1. Technical Field

The present disclosure generally relates to networking relationships between individual users. More particularly, but not exclusively, the present disclosure relates to an electronic invitation extended by a user of a first computing device to another user of a second computing device wherein the two computing devices are connected via a network.

2. Description of the Related Art

In many computing activities, a user of one personal computing device participates in an interactive relationship with a user of another personal computing device. For example, WORDS WITH FRIENDS is a multi-player word computer game played on personal computing devices. Each player typically has access to a personal computing device. The personal computing device has a display and an input mechanism, such as a keyboard or touch screen, which permits a user of the personal computing device to input information into the personal computing device.

In the WORDS WITH FRIENDS computer game, each player sees a representation of a gridded playing surface on the display of their personal computing device. The gridded playing surface serves as a representation of a game board, and each player sees the same game board. One player takes a turn building a word in a “crossword puzzle” style on the gridded playing surface displayed on the computer device, and the player accumulates “points” based on factors such as the complexity of the word, the number of letters, and the overlap of letters in the new word with letter(s) of words previously played and present on the playing surface.

FIG. 1 illustrates a representation of a conventional crossword puzzle-style game playing session 10. A computer network 12 (e.g., the Internet) communicatively couples a first personal computing device 14 to a second personal computing device 16. A first player 18, Player A, controls one portion of the playing session with the first personal computing device 14. A second player 20, Player B, controls another portion of the playing session with the second personal computing device 16.

During the playing session 10, players A and B alternately take turns. When a player takes a turn, the turn is represented on the displays of both computing devices 14, 16. FIG. 1 illustrates Player A taking a turn by entering a word into personal computing device 14. Player A thinks of the word “XRAY” and plays the word as his turn 22. The turn 22 is communicated toward the second personal computing device 16 as a turn notification 22a from player A via network 12. The second personal computing device 16 of Player B receives turn notification 22b from player A as a push notification. That is, the turn notification 22b is “pushed” to computing device 16 without player B having to request the information. The turn 22 is represented on both the first computing device 14 of player A and the second computing device 16 of player B.

In some cases, a computing server 24 facilitates playing session 10. The computing server 24 may keep track of turns taken, points accumulated, and other details of the playing session 10. The computing server 24 may also facilitate communications between Player A and Player B.

To begin a game, Player A invites Player B to the playing session 10. Computing server 24 facilitates the invitation. In more detail, both Player A and Player B have a personal relationship. For example, Player A and Player B may personally know each other as friends, co-workers, relatives, or by some other relationship. Player A may otherwise know Player B through electronic mail or by some other computer networked relationship.

Both Player A and Player B have some personal information stored in computing server 24. When Player A wants to engage Player B in a game, Player A passes an invitation to Player B through computing server 24. Upon acceptance of the invitation, playing session 10 begins.

Computing server 24 may store personal information for player A, player B, and many other players (not shown). In some cases, computing server 24 stores the personal information of thousands of players. In such cases, one player may request computing server 24 randomly send an invitation to another player. If the randomly selected player accepts the invitation, then a new playing session begins.

### BRIEF SUMMARY

In accordance with some embodiments described herein, a computing server facilitates the invitation of one user to another user to participate in an interactive relationship via the computing server. The invitation is precipitated by a first user accessing a representation of content generated by another user. For example, the first user may see a video clip generated by the other user. Upon seeing the video clip, the first user may have a desire to participate in a relationship with the other user even though the first user may not have any previous relationship with the other user.

In accordance with a first embodiment, a non-transitory computer readable medium includes content that causes operations on a computing device. The operations include forming an electronic communication link with a first computing server, and presenting via a user interface a plurality of video clips received from the first computing server, each presented video clip including information associated with a user who generated the presented video clip. The operations further include accepting input from a first user associated with the computing device, the input identifying a video clip selected from amongst the plurality of presented video clips, and requesting communication of an electronic invitation directed to a second user who generated the selected video clip, the electronic invitation inviting the second user who generated the selected video clip to participate in an interactive relationship with the first user via the first computing server. The operations also include receiving an indication that the electronic invitation was accepted by the second user who generated the selected video clip.

The interactive relationship via the first computing server may include participating in a computer-based game. The operations may further include accepting gaming control input from the first user associated with the computing device, the gaming control input associated with taking a turn in the computer-based game. The operations may further include presenting, via the user interface, information related to a turn in the computer-based game played by the second user who generated the selected video clip. The operations may further include accepting video clip rating input from the first user associated with the computing device, the video clip rating input associated with an opinion of at least one video clip of the plurality of video clips received from the first computing server.

In a second embodiment, a method forms a networked relationship. A first act in the embodiment includes presenting user generated content via a computing device, wherein the user generated content includes information associated with a source of the user generated content. A second act, which occurs after the presentation of the first act, includes generating an electronic invitation directed to the source of the user generated content, the electronic invitation including the information associated with the source of the user generated content. A third act includes communicating the electronic invitation to the source of the user generated content.

The method may include receiving an indication via the computing device that the electronic invitation has been accepted. The method may include initiating a turn-based game, the turn-based game including at least two participants, a first participant being a user of the computing device and a second user being a user who accepted the electronic invitation. The user generated content may include at least one of an image, a video segment, an audio segment, an audio/video segment, or a group of words. Presenting user generated content may include presenting a plurality of user generated segments via the computing device, each one of the user generated segments including information associated with a source of the user generated segment, wherein the generated electronic invitation includes information associated with a selected one of the user generated segments. At least one of the user generated segments may be an audio segment, a video segment, or an audio/video segment. At least one of the user generated segments may be an image. At least one of the user generated segments may be a plurality of words of text. Each one of the plurality of user generated segments may be presented in 5 seconds or less.

A third embodiment is directed toward a non-transitory computer readable medium having content that causes operations on a computing server. The operations include forming an electronic communication link with a first computing device, and communicating a plurality of user generated content segments to the first computing device, each segment of the plurality including first information associated with a source of the respective user generated content segment. The operations include selecting, based on second information received from the first computing device, one of the plurality of user generated content segments, and generating an electronic invitation directed to the source of the selected one of the plurality of user generated content segments, the electronic invitation including the first information associated with the source of the user generated content segment. Additionally, the operations include forming an electronic communication link with a second computing device, the second computing device associated with the source of the user generated content segment, and communicating the electronic invitation to the second computing device.

The operations may further include receiving an indication via the second computing device that the electronic invitation has been accepted. The operations may further include initiating a computer-based game, the computer-based game including at least two participants, a first participant being a user of the first computing device and a second user being a user of the second computing device. The operations may further include communicating a second plurality of user generated content segments to the first computing device, each segment of the second plurality including third information associated with a source of the respective user generated content segment; selecting, based on fourth information received from the first computing device, one of the second plurality of user generated content segments; generating a second electronic invitation directed to the source of the selected one of the second plurality of user generated content segments, the second electronic invitation including the third information associated with the source of the user generated content segment; forming an electronic communication link with a third computing device, the third computing device associated with the source of the user generated content segment; and communicating the second electronic invitation to the third computing device. The operations may further include receiving a user-generated rating from the first computing device, the rating associated with at least one segment of the plurality of user generated content segments. The first computing device may be a handheld computing device.

These features with other objects and advantages, which will become subsequently apparent, reside in the details of construction and operation as more fully described hereafter and claimed, reference being had to the accompanying drawings forming a part hereof.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. One or more embodiments are described hereinafter with reference to the accompanying drawings in which:

FIG. 1 illustrates a representation of a conventional crossword puzzle-style game playing session;

FIG. 2 illustrates a software game embodiment incorporating an invitation to participate based on user generated content;

FIG. 3 is a non-limiting block diagram of a computing device;

FIG. 4 illustrates a representative environment incorporating devices that produce and act on invitations to participate based on user generated content;

FIG. 5 is a program flow embodiment of an interactive relationship between a first user and a second user;

FIG. 6 is a program flow embodiment illustrating interactive communications between a plurality of game playing pairs.

### DETAILED DESCRIPTION

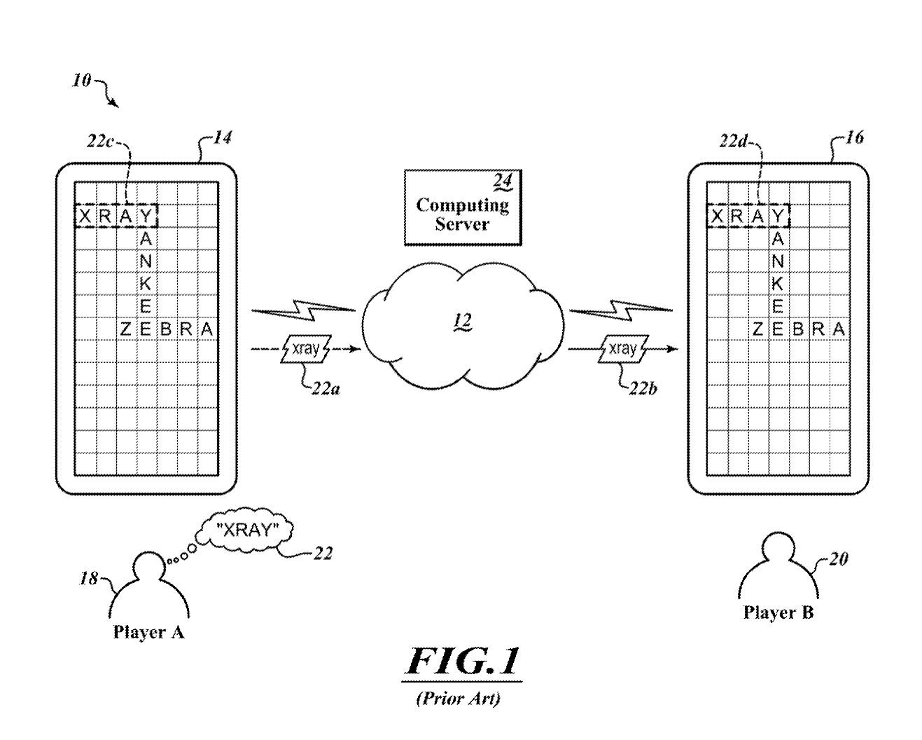

Many benefits are recognized when a user of one personal computing device participates in an interactive relationship with a user of another personal computing device. As users communicate with one another, the users learn more about each other to their mutual advantage. It has been recognized, however, that in the conventional systems such as the crossword puzzle-style game of FIG. 1, the ability to form new relationships is very limited.

Typically, players in an interactive game only participate in an interactive relationship with other players that they already know or that they are already connected with. One connection between players may be a personal relationship wherein the players know each other's electronic mail (email) address.

Another connection may occur between players that are connected across a professional or social networking web site or by some similar mechanism. Yet another connection may exist between players that are both registered with the provider of the interactive game wherein the players know each other by their usernames. In all of these circumstances, the invitation to participate in an interactive relationship is facilitated by the known connection between the players.

In some conventional systems, a computing server facilitates a very limited mechanism through which players can form new relationships. In these systems, the computing server that administers the game includes a random-connection feature. The computing server executes the random-connection feature by randomly pairing registered participants for an interactive relationship. For example, one registered player may indicate to the server a desire to play a game with a random player. The computing server will randomly choose another registered player to invite into a game. The choice made by the computing server may be entirely random, or the choice may be made with additional selection criteria such as matching player preferences stored in user profiles, identifying registered players that are actively using their computing device, or by some other basis. Nevertheless, to a registered player who indicated the desire to play a game with a random player, the invited player represents a random choice.

The shortcomings of the conventional systems (e.g., the crossword puzzle-style game of FIG. 1) have been addressed by the electronic invitation system described herein. The electronic invitation system provides an invitation to participate in an interactive relationship based on user generated content.

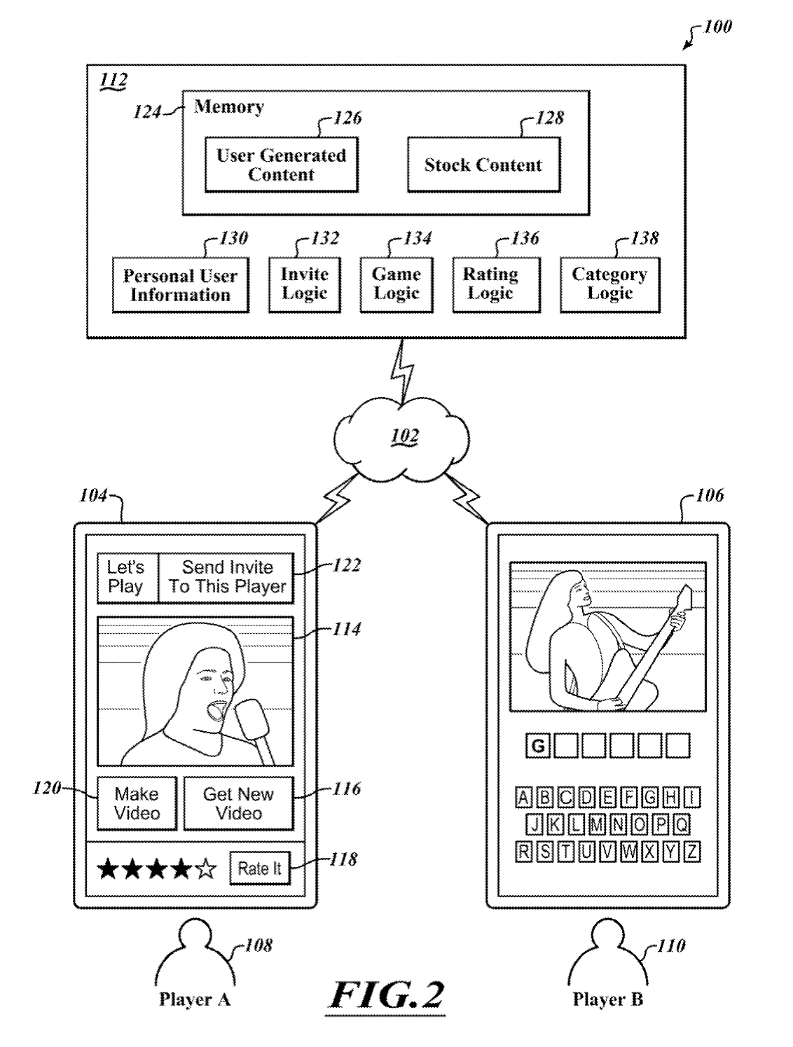

FIG. 2 illustrates a software game embodiment incorporating an invitation to participate based on user generated content. A charades-style game playing session 100 is illustrated in FIG. 2, but other types of games and interactive relationships via computing devices are also contemplated.

The interactive relationship may persist for a long time or for a short time. For example, an interactive relationship may persist only during a single game as illustrated in the charades-style game playing session 100 of FIG. 2. The relationship may last only a few seconds or a few minutes. Alternatively a single interactive relationship may persist for several days or more. The persistence of the interactive relationship over a long period of time may be based on a long game, a game with few moves made by the participants, or for some other reason.

In the game playing session 100 of FIG. 2, a computer network 102 (e.g., a wide area network (WAN) such as the Internet or an extranet, a local area network (LAN), a personal area network (PAN), a peer-to-peer network, or some other type of network) communicatively couples a first personal computing device 104 to a second personal computing device 106. Computer network 102 also couples personal computing devices 104, 106 to a computing server 112. A first player 108, Player A, controls one portion of the playing session with the first personal computing device 104. A second player 110, Player B, controls another portion of the playing session with the second personal computing device 106. The computing server 112 may facilitate the playing session between Player A and Player B by keeping track of turns taken, points accumulated, and other details of the playing session 100. Communication events are passed between the computing devices and server via computer network 102.

During the playing session 100, players A and B alternately take turns. When one of the players takes a turn, the turn is represented on both of computing devices 104, 106. The representation of the turn may be different on each device, but generally speaking, the turn-based game illustrated in playing session 100 is executed when each player knows when the other player takes a turn. Accordingly, a turn taken by one player is typically pushed to the personal computing device of the other player.

In some cases, a computing server 112 facilitates playing session 100. The computing server 112 may keep track of turns taken, points accumulated, and other details of the playing session 100. The computing server 112 may facilitate communications between Player A and Player B. The computing server 112 also has other functionality.

In some cases, the functions of computing server 112 may be incorporated into one of the personal computing devices 104, 106 or distributed between multiple personal computing devices. That is, the computing server 112 can be, but need not be, a separate and distinct computing device. In some cases, a standalone computing server 112 is desirable because the computing server 112 can store large quantities of data and can be accessible to dozens, hundreds, and even thousands of players concurrently. In some other cases, incorporating the functionality of computing server 112 into a personal computing device 104, 106 is desirable because participation in the interactive relationship can be facilitated privately in a small network or other structure (e.g., peer-to-peer sessions).

In the charades-style game playing session 100 of FIG. 2, Player A is viewing a video clip 114 on the user interface of personal computing device 104. Video clip 114 illustrates a woman singing a song, but any other video clip could also be presented. Prior to presenting video clip 114, Player A may have indicated a desire to view a video clip via a “Get New Video” button 116. Alternatively, some other mechanism related to the game playing session 100 may have instigated the presentation of video clip 114.

Video clip 114 represents user generated content (UGC). User generated content includes multimedia content (e.g., audio, video, audio/video), still images, text, tactile feedback, and the like. Audio segments may include only audio or audio integrated with video or still image content. Video segments may include only video or video integrated with audio content. Still images may standalone or may also include audio. Text may be individual words, groups of words, sentences, sentence fragments, and the like. Text may also include symbols. Text may be in any language. The UGC may further include directions to produce tactile feedback on a computing device such as vibration, heat, motion, or some other tactile sensation.

User generated content (UGC) is associated with the source of the content. That is, UGC may include information that identifies the person or persons who are the subject of the UGC, the target of the UGC, the source of the UGC, the creator of the UGC, and the like.

Typically, UGC is represented in a short segment. The short segment may be presentable in less than one (1) second, in less than three (3) seconds, in less than five (5) seconds, in less than ten (10) seconds, or in some other length. Alternatively, or in addition, UGC may exist in a long segment of one or many minutes. From a long segment, short segments may be selected and presented via a user interface of a computing device.

A segment of UGC may include the whole of the stored content or may only include some portion of the stored content. Along these lines, a segment, portion, or clip, may be thought of as a recording of only some part of a larger particular event. For example, a segment, portion, or clip of UGC may include a recording of five (5) seconds of a singer singing the national anthem. The stored 5-second recording is described as a segment, portion, or clip of UGC. Additionally, less than five (5) seconds of the stored 5-second recording is also described as a segment, portion, or clip of the UGC.

With respect to the UGC example provided, i.e., that of a singer singing the national anthem, many types of UGC may be recorded. For example, video may be recorded, audio may be recorded, and audio/video may be recorded. The text of the anthem may be recorded. Percussion from the singing or other tactile representations may be recorded. The recording may be a true representation of the singing, or the recording may be creatively manipulated by the singer or recorder. Such manipulation may be with substituted words in the song, electronic audio distortion, video enhancement, and many other manipulations.

The UGC presented on the personal computing device 104 of FIG. 2 was delivered from the computing server 112 when Player A engaged the “Get New Video” button 116. In FIG. 2, Player A engaged the “Get New Video” button 116 with a pointing device (e.g., a finger, stylus, etc.) on a touch screen, but other mechanisms could also be used. In some cases, the computing server 112 delivers only one segment of UGC at a time. In other cases, a several UGC segments are delivered for presentation in a slide show format, a matrix format, or in some other format.

In some cases, when Player A engages the “Get New Video” button 116, the player is presented with additional options. For example, Player A may be able to request similar UGC to that which was just presented. Player A may be able to specify certain other factors for the type of UGC that is being requested, wherein such factors include quality, category, geographic location of the source of the UGC, common “preference” settings between Player A and the person who is the source of the UGC, and many other factors.

Upon viewing the video clip 114, Player A has several options within the playing session 100. Player A may request one or more additional clips of UGC (e.g., video clips) by engaging the “Get New Video” button 116. Among other things, Player A may also rate the UGC that is presented, create UGC, and send electronic invitations to other players.

In FIG. 2, five stars are illustrated along with a “Rate It” button 118. After UGC is presented, Player A may feel strongly enough about the UGC to share an opinion. Many different mechanisms may be provided for Player A to share an opinion. In FIG. 2, Player A has a star rating system available wherein no stars or one star can indicate poor quality, two, three, or four stars can indicate rising levels of average quality, and five stars can indicate good quality. Upon selecting a desired number of stars, Player A can engage the “Rate It” button 118 to send the opinion to the computing server 112.

In some embodiments, the “Rate It” button 118 may provide Player A with additional opportunities to share an opinion. For example, Player A may be able to type in a written review of the UGC. Player A may also be able to categorize the UGC. In some cases, the computing server 112 provides direction and context with respect to quality ratings and categorization. In other cases, Player A determines the context of the quality ratings and categorization. “Quality” may refer to the quality of a singer, how funnily a song is sung, the ability of the singing to evoke emotion, or any other conceivable subjective opinion. Categorization may include the genre of song, personally identifiable features of the singer (e.g., age, gender, and the like), instruments accompanying the song, the name of the song, geographic or circumstantial setting of the song, and any other conceivable categories. It is recognized that quality ratings and categorization are broadly understood.

The user interface of personal computing device 104 illustrated in the embodiment of FIG. 2 includes a “Make Video” button 120. The “Make Video” button 120 permits Player A to create a video using the personal computing device 104. One or more videos created by Player A can be uploaded to the computing server 112.

When the video is uploaded to computing server 112, the video is stored in a memory associated with the computing server 112. Source information is also associated with the video and stored. In some cases, the computing server 112 generates the source information from a user profile associated with Player A. In other cases, the source information is associated by the personal computing device 104 and passed to computing server 112. Other information associated with the video may also be stored.

When the personal computing device 104 uploads the source information to computing server 112, the personal computing device 104 creates the associated information. In some cases, source information identifying Player A is automatically associated with the created video. The source information may be integrated in the video or separately sent to computing server 112 along with the created video. In some cases, Player A may also add or modify source information associated with the video. For example, Player A may include the identity of the singer in the video as the source information, the company name responsible for uploading the video as the source information, or Player A may identify some other source. Player A may further generate categorization information to be associated with the video.

It is understood that FIG. 2 is discussed in the context of video segments, portions, or clips, but the user generated content is not so limited. That is, a participant in a system that includes an electronic invitation to participate based on user generated content may include mechanisms to create, store, categorize, present, rate, and otherwise interact with user generated content of any form.

The user interface of personal computing device 104 illustrated in the embodiment of FIG. 2 includes a “Let's Play! Send Invite to This Player” button 122. After UGC is presented, Player A may make a selection of a certain UGC segment. The selection can be the most previously presented UGC segment. Alternatively, the selection may be from a matrix or other grouping of UGC segments (e.g., thumbnail images clipped from recently presented UGC segments). Upon making a selection, Player A will engage the “Let's Play! Send Invite to This Player” button 122.

When Player A engages the “Let's Play! Send Invite to This Player” button 122, an electronic invitation is generated and communicated to the source of the UGC presented on the personal computing device 104 of Player A. In some cases, the electronic invitation is generated by the personal computing device 104. In other cases, the personal computing device 104 passes a request to computing server 112 for the electronic invitation, and computing server 112 generates and sends the invitation.

In FIG. 2, the electronic invitation from Player A is directed to the source of the selected UGC segment. Typically, the source of the selected UGC segment is the user (e.g., Player C, not shown) that made the UGC segment available to Player A. In the embodiment of FIG. 2, the selected UGC segment was uploaded to computing server 112 by Player C (not shown), and Player C is the source of the UGC segment.

Turning back to FIG. 2, Player A has been engaged in a charades-style game playing session 100 with Player B. Player A had been presented with UGC generated and uploaded by Player C (not shown). Player A has found the UGC to be very appealing, and Player A would like to begin a new game playing session with Player C. Concurrent to the game playing session 100 with Player B, Player A engages the “Let's Play! Send Invite to This Player” button 122, and an electronic invitation is generated and communicated to Player C (not shown).

In some embodiments, the electronic invitation is pushed to a personal computing device of Player C, and Player C accepts the invitation. When Player C accepts the invitation, Player A will receive an indication via the user interface of personal computing device 104 that the invitation has been accepted. Player A may then form an electronic communication link with a personal computing device of Player C, and while Player A is participating in game playing session 100 with Player B, Player A concurrently initiates a new game playing session with Player C.

The charades-style game playing session 100 of FIG. 2 is facilitated via a computing server 112. Computing server 112 includes several modules. A memory module 124 includes a user generated content module 126 and a stock content module 128. The user generated content module 126 is configured to store user generated content (UGC) uploaded by users associated with the computing server 112. The stock content module 128 is configured to store other stock content (e.g., audio, video, audio/video, text, tactile information, and the like) that is not directly sourced by a user who is registered with the computing server 112. The stock content is available to all players engaged in game sessions facilitated by computing server 112.

Computing server 112 includes a personal user information module 130. The personal user information module 130 generally creates a record (e.g., database entry) for each user registered or otherwise associated with computing server 112. The record may include identification information such as an ID number. Typically, the identification information is unique within the computing server 112 and the systems that computing server 112 facilitates. That is, by way of the identification information, an individual user (e.g., Player A, Player B, etc.) can be particularly identified. The identification information can be associated with a particular UGC segment (e.g., a video clip) to identify the user who generated or uploaded the particular UGC to the computing server 112.

The personal information module 130 may also store many other pieces of information related to a registered user. For example, particular preferences or categories of preferences may be stored. A geographic location associated with the registered user may be stored. Privacy settings, parental guidance setting, and other settings may be stored. An indication of whether a particular registered user is actively participating in a game session may also be stored. A “time of last turn” may be stored, wherein the time of last turn can be measured in any units or format and can indicate how recently a registered user has participated in an interactive relationship communication via the computing server. Other information can also be stored by the personal user information module 130.

The computing server 112 in the embodiment of FIG. 2 includes an invite logic module 132. Invite logic module 132 can perform many functions related to an electronic invitation. The invite logic module 132 may receive requests from computing devices to send electronic invitations. The invite logic module 132 may also receive requests from computing devices for information such that the computing device can generate an electronic invitation.

Invite logic module 132 may process certain categorization information, rating information, personal preference information, and other information to locate UGC content for presentation by a computing device.

Invite logic module 132 can be configured to process withdrawals of invitations, rejections of invitations, and acceptances of invitations. That is, when a first registered user (e.g., Player A) requests communication of an electronic invitation to a second registered user (e.g., Player B), invite logic module 132 facilitates the generation and communication of the invitation. The electronic invitation may be pushed to the second registered user and left pending for a period of time. Later, if the first registered user desires to withdraw the electronic invitation, the invite logic 132 can delete the invitation thereby removing the pushed invitation. The second registered user may or may not ever be aware that the invitation was pushed to the computing device associated with the second registered user.

When a registered user rejects an electronic invitation, an indication of the rejection may be communicated by the invite logic 132 to the registered user who instigated the sending of the invitation. For example, a first registered user (e.g., Player A) may request communication of an electronic invitation to a second registered user (e.g., Player B), which communication is facilitated by invite logic module 132. The second registered user may review the electronic invitation and decline (i.e., reject) the invitation. In some cases, the second registered user declines the invitation by deleting the electronic invitation that was pushed to the personal computing device associated with the second registered user. In other cases, the second registered user takes action with an associated computing device to expressly reject the invitation. Upon rejection of the electronic invitation by the second registered user, an indication of the rejection may be communicated to the first registered user. In some cases an express notice of the rejection is communicated to a computing device associated with the first registered user. In other cases, an indication of the pending electronic invitation that is presentable on the computing device of the first registered user is deleted. Other mechanisms to indicate the pending status of an electronic invitation and the rejection (i.e., decline) of the electronic invitation could also be employed.

One registered user may accept an invitation to participate in an interactive relationship with another registered user. For example, a first registered user (e.g., Player A) requests communication of an electronic invitation to a second registered user (e.g., Player B), which communication is facilitated by invite logic module 132. Subsequently, the second registered user engages some portion of a user interface on an associated computing device to indicate an acceptance of the electronic invitation. The invite logic module 132 may then facilitate a communication link between the computing devices associated respectively with the first and second registered computing devices. The communication link can be used for a game session (e.g., charades-style game playing session 100 of FIG. 2) or for some other interactive relationship. Once formed, the communication link may include the computing server 112 as a conduit between the linked communication devices. Alternatively, once formed, the communication link may be a one-to-one communication link between the linked communication devices wherein the computing server 112 is either made aware of the activity between the linked communication devices or is unaware of any such activity.

Accordingly, invite logic module 132 may further include logic to administer communication links between devices. That is, a first communication link may be formed between the computing server 112 and personal computing device 104. A second communication link may be formed between computing server 112 and personal computing device 106. The combination of the two communication links may further be recognized as a single communication link between personal computing device 104 and personal computing device 106 when an interactive relationship has been formed. The computing server 112 may be a conduit for communications between the personal computing devices 104, 106. Alternatively, the personal computing devices 104, 106 may form a connection without any intervention by the computing server 112.

Furthermore, the communication links administered by the invite logic module 132 need not persist for the duration of an interactive relationship. That is, for the duration of the interactive relationship, the invite logic module may retain information necessary to establish and perform communications between computing devices, but such communications may be formed and broken as each registered user directs the communications. In addition, once the link is formed, the individual computing devices may retain the information necessary to form, break, and re-form the communications link. In such cases, the invite logic module 132 may receive an indication of communication events between computing devices.

In some cases, an invite logic module 132, a personal user information module 130, a “Get New Video” input mechanism, and a “Send Invite” input mechanism 122 can operate individually or cooperatively to enhance the pool of prospective relationships that a user associated with a personal computing device 104 can form. Particularly, though not exclusively, a user will be presented with UGC that the user will find compelling.

The computing server 112 is configured to identify UGC for presentation on the personal computing device 104 of the associated user. In some cases, the computing server 112 cooperates with the personal user information module 130 in order to identify the UGC for presentation.

In one embodiment, a geographic location associated with a user (e.g., Player A) is retrieved. The invite logic module 132 or another module of the computing server 112 chooses UGC for presentation on the personal computing device 104 associated with the user based on the geographic location. In one example, the personal computing device 104 may have a “Get New Video From Users Near Me” button in addition to or in place of the “Get New Video” button 116. In another example the personal computing device 104 may have a “Send Invite To Player Near Me” button in addition to or in place of the “Send Invite To This Player” button 122. Other input mechanisms are also possible. In these cases, it is recognized that the geographic location is used as a basis for the selection of UGC and/or the identification of users to invite.

In another embodiment, one or more other datums of personal user information may be used as a basis for the selection of UGC for presentation and/or the identification of users to invite. The personal user information may include geographic location, personal preferences, demographics, favorites, and many other types of information. One or more criteria stored in the personal user information module 130 for one user may be matched with criteria in the personal user information module 130 of one or more other users. The matching of criteria can be used as a basis for selecting UGC for presentation, for identifying users to invite, or for other reasons. For example, in such embodiments, the personal computing device 104 may have a “Get New Video From Users Like Me” button in addition to or in place of the “Get New Video” button 116. In another example in such embodiments, the personal computing device 104 may have a “Send Invite To A Player Like Me” button in addition to or in place of the “Send Invite To This Player” button 122.

With respect to a geographic location, user preferences, or other selection criteria useful for identifying UGC for presentation or users to invite, a particular user in some embodiments may provide input in the selection processes. For example, with respect to geography, a user may provide input settings to indicate a desire to receive UGC or access to other users within a certain radius, within a certain city, or within some other geographic criteria. With respect to personal user information, a much wider variety of selection criteria can be chosen. For example, one user may desire UGC or invitation access to another user based on demographic information, sports team affiliation, hobbies, vocation, education, and many other criteria. A user may set exclusive criteria for matching, a minimum number of categories for matching, or one or more other characteristics that can be used to match one user with another user.

A communications link between two registered users may be exploited by a game logic module 134. In the embodiment of FIG. 2, the game logic module 134 facilitates the initiation and execution of the charades-style game playing session 100. Game session 100 is a turn-based game in the embodiment of FIG. 2. Accordingly, communication events between personal computing devices 104, 106 are asynchronous and such events may occur either very frequently or very seldom based on the frequency at which the registered users (i.e., Players A, B) take turns.

It is understood that the game logic module 134 may be configured for only one type of game (i.e., the charades-style game playing session 100 of FIG. 2). Alternatively, the game logic module 134 may be configured for many different types of games such as a jigsaw puzzle game, a word-based game, or other types of game. Game logic module 134 is particularly suited for directing operations in an interactive relationship conducted via a computing server between two participants. The operations that the game logic module 134 directs include passing user generated content (UGC) to a computing device associated with one of the participants, and permitting the participant to send an electronic invitation to a source associated with the UGC. If the source associated with the UGC accepts the invitation, then the game logic module 134 will direct and manage a new interactive relationship between the participant that sent the electronic invitation and the participant that accepted the electronic invitation.

Computing server 112 includes a rating logic module 136 and a category logic module 138 in the embodiment of FIG. 2. The rating logic module 138 facilitates the capture and processing of ratings associated with UGC segments. For example, when a UGC segment is presented on a personal computing device, a user associated with the personal computing device may be inspired to share a rating opinion of the UGC. The UGC segment may be presented to only a single user, to a few users, or to dozens, hundreds, or thousands of users. In most cases, only some of the users that accessed the presented UGC content will provide rating information. Accordingly, any given UGC segment may have associated therewith a large quantity of user generated rating information, a small amount of user generated rating information, or no user generated rating information. In some cases, the received user generated information is consolidated to form a simple average which is then associated with the UGC segment. In other cases, different mechanisms are used to create a rating for a UGC segment. For example, rating information may be weighted according to age or quantity. Other factors can also be used to generate a rating to associate with the particular UGC segment. In some cases, users generate rating information used to calculate and assign a rating to UGC. In other cases, administrators of the rating logic module 136, in addition to or as an alternative to users, generate rating information used to calculate and assign a rating to UGC.

Rating logic module 136 may cooperate with the game logic module 134 to present participants in a game with the “best” UGC segments. That is, when some users submit a high rating for a certain UGC segment, the rating logic module 136 will associate a high rating to the UGC segment. The high rating can be used by the game logic module 134 to more frequently select highly rated UGC segments for presentation. Accordingly, game participants are provided with presentable UGC that is deemed “best” by other game participants more frequently than the participants are provided with UGC having lower ratings. The rating logic module 136 includes logic to direct passage of a wide variety of UGC having a various rating levels to participants, while also passing the highest rated UGC more frequently. In some cases, the rating logic module 136 may identify a “UGC of the day” and promote the selected UGC to all users that are active on that day.

The category logic module 138 is configured to assign particular categorization information to each UGC segment stored in the computing server 112. The categorization information generally includes information such as the type or form of content represented by the UGC (e.g., video, audio, audio/video, text, tactile, and the like). Categorization information may also include geographic information, source information, and length information. The UGC may be categorized by topic, genre, age, minimum rating, maximum rating, and number of times used as a basis for generating an electronic invitation. Many other categories for distinguishing UGC can also be formed and assigned. In some cases, users generate categorization information used to calculate and assign the UGC to one or more categories. In other cases, administrators of the category logic module 136, in addition to or as an alternative to users, generate categorization information used to calculate and assign the UGC to one or more categories.

The category logic module 138 cooperates with the game logic module 134 to present desirable, relevant UGC to participants in an interactive relationship. The category logic module 138 may access information from a personal user information module 130 to choose UGC that will be passed. For example, in reference to FIG. 2, the category logic module 138 may access a personal information record associated with Player A in order to identify UGC within categories preferred by Player A. Additionally, a particular game may direct that UGC be related to a particular category, and in such cases, the category logic module 138 will identify UGC in a category that compliments that particular state of the game session 100.

In still further reference to FIG. 2, session 100 is a turn-based, charades-style game playing session. In the session, Player A may be trying to present clues to Player B that are topically related to a certain musical instrument. In such a case, the category logic module 138 may cooperate with the game logic module 134 to present UGC from a music category, a musical instrument category, or from some other related category.

The particular logic modules of computing server 112 cooperate with the memory 124 of computing server 112. In fact, the respective logic modules 130, 132, 134, 136, 138, and other logic modules may comprise software instructions that execute the functions of the respective logic module, wherein the software instructions are stored in memory 124. Furthermore, the logic modules may also store data to memory 124 and retrieve data from memory 124 in any useful matter.

In FIG. 2, a charades-style game playing session 100 engages two registered user players, Player A and Player B. One player, Player A in the embodiment of FIG. 2, has invited the other player, Player B, into an interactive relationship to play the charades-style game. Player B uses an associated personal computing device 106 to review UGC clues provided by Player A. Player A takes a turn by directing communication of the UGC clue. Player B takes a turn by passing gaming control input into computing device 106. The gaming control input of Player B is based on the presented UGC. As illustrated in the embodiment of FIG. 2, the gaming control input of Player B has caused a letter “G” to be filled into a six-letter space for a guess.

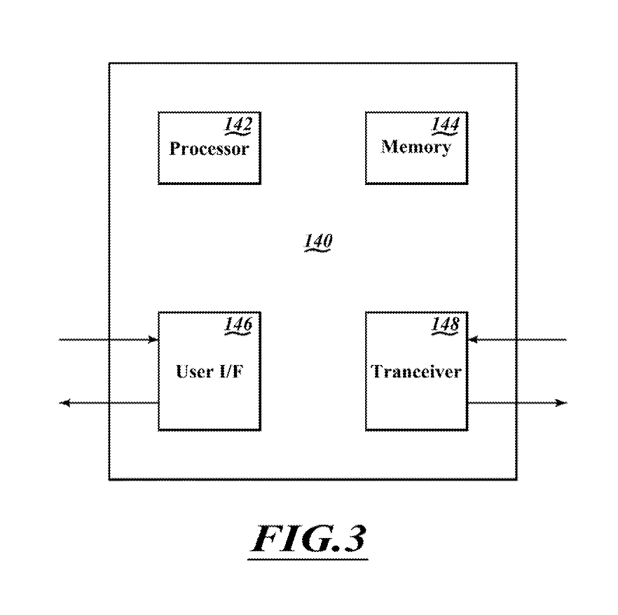

FIG. 3 is a non-limiting block diagram of a computing device 140 embodiment. The computing device 140 embodiment of FIG. 3 includes representative hardware and software that may also be found in computing server 112 (FIG. 2). The computing device 140 of FIG. 3 includes representative hardware and software that may be found in personal computing devices 104, 106 (FIG. 2). The computing device 140 may be any type of computing device configured to pass user generated content and electronic invitation information as described herein. For example, the computing device 140 may be a server, a personal computer, a laptop computer, a smart TV, a handheld device (e.g., a smartphone, a thin client, a tablet device, or the like) or some other type of computing appliance.

The computing device 140 of FIG. 3 includes a processor 142, a memory 144, a user interface 146, and a transceiver 148. For simplicity, several components of computing device 140 such as buses, power supplies, and other circuits and modules have not been illustrated.

The processor 142 of computing device 140 may be a single processing device or a collection of two or more processing devices. The processing device or devices may be central processing units (CPU), digital signal processors (DSP) or any other type of processing unit.

As recognized by one skilled in the art, computing device 140 will include one or more memories 144, each memory 144 comprising any combination of volatile and non-volatile computer readable media for reading and writing. Volatile computer readable media includes, for example, random access memory (RAM). Non-volatile computer readable media includes, for example, read only memory (ROM), magnetic media such as a hard-disk, an optical disk drive, and other memory devices such as a flash memory device, and/or the like. In some cases, a particular memory is separated virtually or physically into separate areas, such as a first memory, a second memory, a third memory, etc. In these cases, it is understood that the different divisions of memory may be in different devices or embodied in a single memory

The user interface 146 of computing device 140 is non-limiting. The user interface may include one or more of any type of display device integrated with or connectable to the computing device 140. The user interface 146 is particularly configured to present video content, still image content, audio content, text content, tactile content, or other content to a user associated with the computing device 140. The user interface 146 may include one or more audio and tactile output devices such as speakers, piezo transducers, vibrators, and the like. The user interface 146 may further include other output devices such as printers, memory card, LED indicators, and the like. The user interface may further include one or more wired or wireless input devices such as touch screens, keyboards, computer mice, trackballs, microphones, cameras, infrared remote controls, RF devices, motion sensors, and the like. The user interface 146 of FIG. 3 includes non-limiting reference arrows to indicate that information of any suitable type may be passed out of the computing device 140 or passed into the computing device 140.

The transceiver 148 of computing device 140 provides operative logic including electronic circuitry and/or software to uni-directionally or bi-directionally communicate electronic data from the computing device 140 to another computing device. The transceiver 148 may include wired logic, wireless logic, optical logic, or other electronic communication logic. In some cases, the transceiver 148 includes a media access control (MAC) device. The transceiver 146 may be arranged to communicate over short distances (e.g., personal area networks, direct device-to-device communications) or long distances (commercial cellular services such as GSM, CDMA, etc.). In some cases, a Bluetooth transceiver is provided. In some cases, an IEEE 802.11 WiFi transceiver is provided. In some cases, an RS-232, RS-485, or USB transceiver is provided. In some cases, a cellular transceiver chipset and associated peripheral circuitry such as an antenna is provided. Other wireless and wired communication transceivers may also be provided. The transceiver 146 of FIG. 3 includes non-limiting reference arrows to indicate that electronic information of any suitable type may be communicatively passed out of the computing device 140 or passed into the computing device 140.

Computing device 140 embodiments further include operative software found in a conventional computing device such as an operating system, software drivers to direct operations through input/output (I/O) circuitry, networking circuitry, and other peripheral component circuitry. In addition, computing device 140 may include operative application software such as network software for communicating with other computing devices, database software for building and maintaining databases, and task management software for distributing the communication and/or operational workload amongst various CPU's. In some cases, a computing device 140 is a single fixed or mobile hardware machine having the hardware and software listed herein, and in other cases, a computing device 140 is a networked collection of hardware and software machines working together in a server farm or “cloud” to distribute and execute the functions of computing device 140. The conventional hardware and software of computing device 140 is not shown, for simplicity.

The computing device 140 of FIG. 3 may include logic modules such as those illustrated in FIG. 2. One or more parts of the logic modules may be configured as software components loaded into the memory 144 of computing device 140. In some embodiments, the logic modules are stored as one or more files in memory 144. In some embodiments, portions of the memory 144 are a non-transitory computer readable media (CRM) configured to store computing instructions executable by processor 142.

Software files stored in memory 144 may include one or more computer programs that operate individually or as part of a larger computer program. Alternatively or in addition, each file may include data or other computational support information for one or more of the logic modules. The logic modules typically direct the processor 142 to execute a set of instructions stored on computer readable media (i.e., memory 144).

Several program modules may be stored within one or more of the memory structures of memory 144. The program modules present executable instructions to the processor 142 to cause operations on the computing device 140.

Memory 144 may store an operating system. The operating system typically provides program and device management services for the computing device 140. Examples of operating systems include any one or more of various versions of LINUX, MICROSOFT WINDOWS, UNIX, and others.

Memory 144 may store web page management and administration tools. For example, memory 144 may optionally store one or more web server modules, database server interface modules, script processor modules, and web browser modules. Examples of web server modules include APACHE, MICROSOFT INTERNET INFORMATION SERVICES (IIS), NGINX, and GOOGLE WEB SERVER (GWS). Web servers typically deliver web pages to client devices. Often, the requests are made using Hypertext Transfer Protocol (HTTP), and the web pages are delivered as Hypertext Markup Language (HTML) documents along with any additional content that is called out by the document (e.g., images, style sheets, scripts, functions, and the like).

Memory 144 may store database implementation and management modules. Examples of database server interface modules include ORACLE/SUN MICROSYSTEM MYSQL, MICROSOFT SQL SERVER, and APACHE DERBY. A database server interface module typically implements a structured query language (SQL) that performs input and output functions on a relational database. In some cases, a database server interface module implements a data storage repository (e.g., a relational database) in the same hardware that implements the database server, and in other cases, the repository is distributed between several different machines. In some cases, the data repository is implemented in a database server and the database server interface module is implemented in a computing device 140.

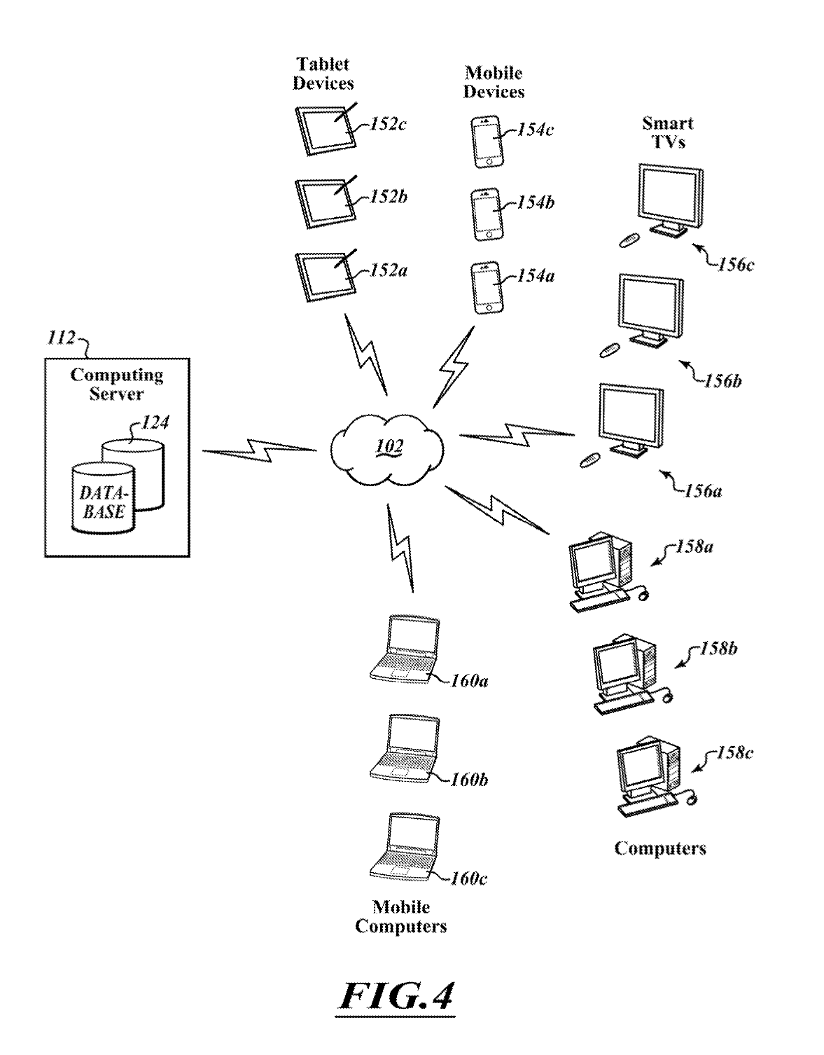

FIG. 4 illustrates a representative environment 150 incorporating devices that produce and act on invitations to participate based on user generated content. A network 102 couples together a variety of computing devices. A computing server 112 facilitates interactive relationships amongst the computing devices. Within the environment, tablet devices 152a-152c, handheld devices 154a-154c (e.g., smartphones), smart TV devices 156a-156c, personal computer devices 158a-158c, and mobile computer devices 160a-160c (e.g., laptop computers) are illustrated. In fact, dozens, hundreds, or thousands of computing devices may communicate with each other and with computing server 112 via network 102.

Within the environment of FIG. 4, many software game embodiments of the type illustrated in FIG. 2 may be concurrently executed. One or more users may be associated with each of the computing devices 152-160. The users may be registered with the computing server 112. By registration, each user may be assigned a unique identifier, and each user may have an associated personal user profile created and administered by the computing server 112. The personal user profile can include information related to privacy settings, personal preference settings, and other settings.

Registration of a user allows the user to access game systems and other systems facilitated by the computing server 112. Accordingly, a registered user may upload user generated content (UGC) to the computing server 112. A registered user may access UGC generated and uploaded by other users. When a first user accesses UGC generated by a second user, the first user may communicate an electronic invitation to the second user. The electronic invitation invites the second user to participate in an interactive relationship via the computing server 112.

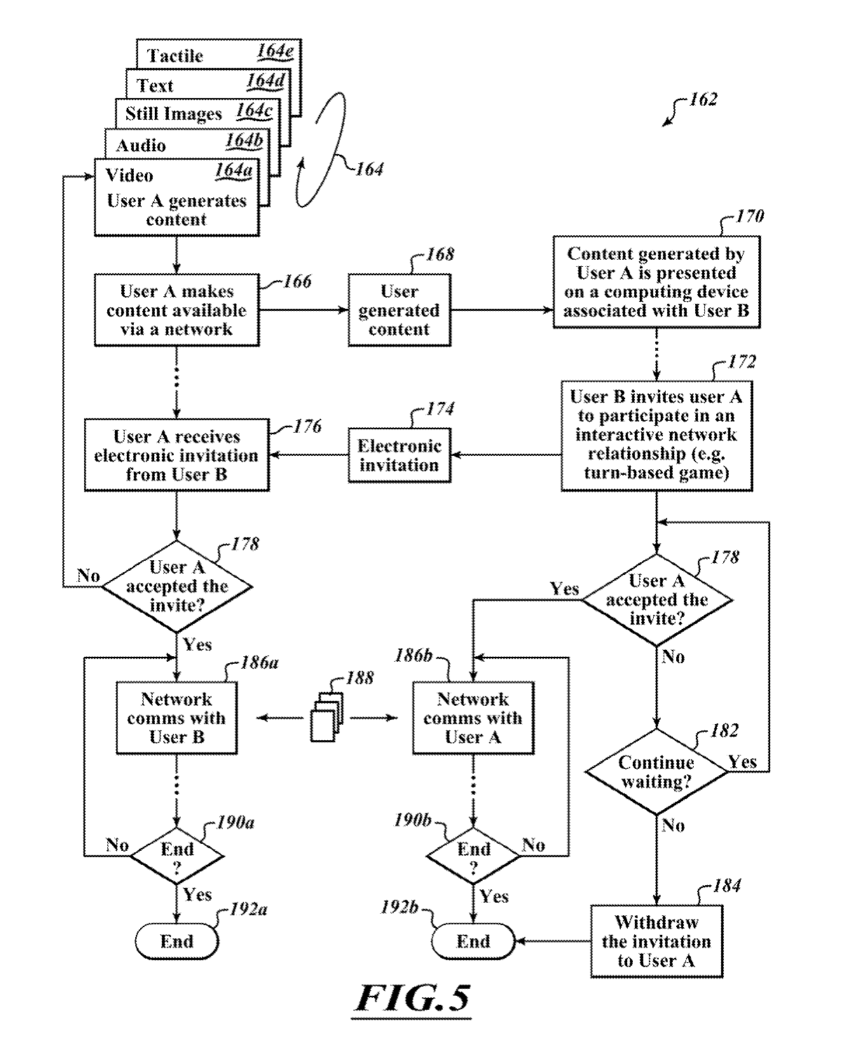

FIG. 5 is a program flow embodiment 162 of an interactive relationship between a first user and a second user. The program flow 162 may be executed in the context of a turn-based game (e.g., FIG. 2). Alternatively, or in addition, the program flow may also be executed in some other context.

The program flow 162 begins at a repeating action performed by a registered user, User A. At 164, User A repeatedly (i.e., one or more times) creates user generated content (UGC).

At 164a, User A may create video content.

At 164b, User A may create audio content.

At 164c, User A may create still image content.

At 164d, User A may create text content.

At 164e, User A may create tactile content.

At 164, User A may create one or more types of UGC. The types of UGC created by User A may be mixed. For example, User A may record a video of a singer in a heavy-metal band. User A may record the entire song, several songs, or merely a segment, portion, or clip of the song. The recording by User A may include video, audio, or video and audio. The same or different UGC may record still images, text, or even tactile impressions of the loud, percussive, heavy-metal song.

At 166, User A makes the UGC created at 164 available via a network. For example, User A may upload the UGC to a computing server 112 (FIGS. 2, 4). The UGC may be categorized and stored in database. User A may participate in the categorization. Alternatively, or in addition, logic in the computing server or human administrators of the computing server 112 may visually, auditorily, tactily, or programmatically analyze the UGC and categorize the UGC.

User A may store a single UGC segment, portion, or clip as an electronic file. Alternatively, User A may store two or more files of UGC. The computing server may categorize and store the UGC in an accessible relational database.

Some or all of the UGC that is generated and made available by User A at 166 is accessed by User B and communicated to a computing device associated with User B at 168. The computing device associated with User B may be any type of device 152-160 such as illustrated in FIG. 4. Referring back to FIG. 2, the computing device associated User 2 may present a “Get New Video” button via a user interface. When User B engages the “Get New Video” button or other mechanism, UGC is accessed and communicated to the computing device associated with User B as illustrated at 168.

At 170, the UGC generated by User A is presented on the computing device associated with User B. Presentation is performed via the user interface of the computing device; e.g., via a display, speaker, piezo transducer, vibrator, or some other user interface device.

An aperiodic amount of time may pass between the acts called out at 170 and 172, which are generally associated with User B. A same or different aperiodic time may pass between the acts called out at 166 and 176, which are generally associated with User A. Stated differently, in the program flow embodiment 162, there exist some communicative events that are performed in a particular order. Nevertheless, actions undertaken by User A are performed on a time sequence set by User A. While User A may not be able to perform some actions until other actions are first performed by User B, once said actions are performed by User B, User A then may act freely according to a time sequence determined by User A. Along the same lines, communicative events performed by User B are performed according to a time sequence determined by User B.

Turning back to the program flow embodiment 162, User B has been exposed to UGC created by User A at 170. At some point, based on the exposure to the User A generated UGC, User B is inspired to connect with User A. At 172, User B invites User A to participate in an interactive network relationship (e.g., a turn-based game). The invitation from User B to User A is an electronic invitation communicated at 174. The electronic invitation includes a unique identifier drawn from information associated with the particular UGC that inspired User B. The unique identifier distinguishes User A from any other user. The electronic invitation may be communicated as a push notification to a computing device associated with User A. In many cases, the computing device associated with User A that was used to generate the UGC is the same computing device that receives the push notification electronic invitation. In other cases, a different computing device associated with User A receives the electronic invitation. It is thus understood that the actions performed and related to User A are particularly associated with the unique identifying information that distinguishes User A from other users. Accordingly, User A can perform actions on any computing device insofar as the actions are associated with User A. Along these lines, actions performed by User B and other users are associated with the particular unique identifying information assigned to the respective user.

At 176, User A receives the electronic invitation from User B via an associated computing device. User A may accept the electronic invitation, reject the electronic invitation, or ignore the electronic invitation. At 178, User A determines whether the electronic invitation will be accepted. In the interim time before an invitation is accepted (i.e., if User A is unaware of the electronic invitation or has chosen to ignore the invitation), User A may return to 164 and generate additional content. If User A rejects the electronic invitation, User A may return to 164 and generate additional content. In the program flow at 176, 178, User A is permitted to determine the time sequences that will be followed.

During a time period in the program flow at 176, 178, User B determines the time sequences that User B will follow. At 180, User B determines whether or not User A has accepted the electronic invitation to participate in an interactive relationship. If User A has not accepted the electronic invitation, program flow advances to 182 where User B determines whether or not to continue waiting. If User B determines not to continue waiting for User A to take action on the electronic invitation, program flow passes to 184. At 184, User B withdraws the electronic invitation to User A.

Typically, User B will spend an amount of time at 180, 182 according to a time sequence determined by User B. In some cases, however, at 176, 178, User A will reject the electronic invitation. In such cases, the electronic invitation may be automatically removed (e.g., deleted) by the computing server 112. Accordingly, in such cases, User B no longer has an electronic invitation to wait for. In such cases, the program flow with respect to User B will advance to 192b or perhaps 170.

Along the same lines, User A will typically spend an amount of time at 176, 178 according to a time sequence determined by User A. In some cases, however, at 182, User B will decide to withdraw the electronic invitation. In such cases, the electronic invitation may be automatically removed (e.g., deleted) by the computing server 112. Accordingly, in such cases, User A no longer has an electronic invitation to act on. In such cases, the program flow with respect to User A will advance to 192a or perhaps 164.

At 186a and 186b, User A has accepted the electronic invitation extended by User B. User A and User B initiate and begin to participate in an interactive relationship via the computing server 112. More specifically, at 186a, User A performs network communication events with User B. At 186b, User B performs network communication events with User A.

The program flow at 188 indicates an indeterminate number of communication events asynchronously passed between communication devices associated respectively with User A and User B. The aperiodic times that pass between during the asynchronous communications are represented by the dotted lines between 186a and 190a with respect to User A and between 186b and 190b with respect to User B. With respect to FIG. 2, the communication events at 188 may represent turns taken by each of User A and User B in a turn-based charades-style game playing session 100.

At 190a and 190b, User A and User B respectively act on an ending event. The ending events may be the end of a game or a withdrawal from the interactive relationship for any reason. If both User A and User B choose not to end the game or if the game does not naturally terminate, then the interactive relationship will persist, and program flow for User A will return to 186a, 190a and program flow for User B will return to 186b, 190b.

Program flow, and thus the interactive relationship, ends at about the same time for both User A and User B at 192a, 192b respectively.

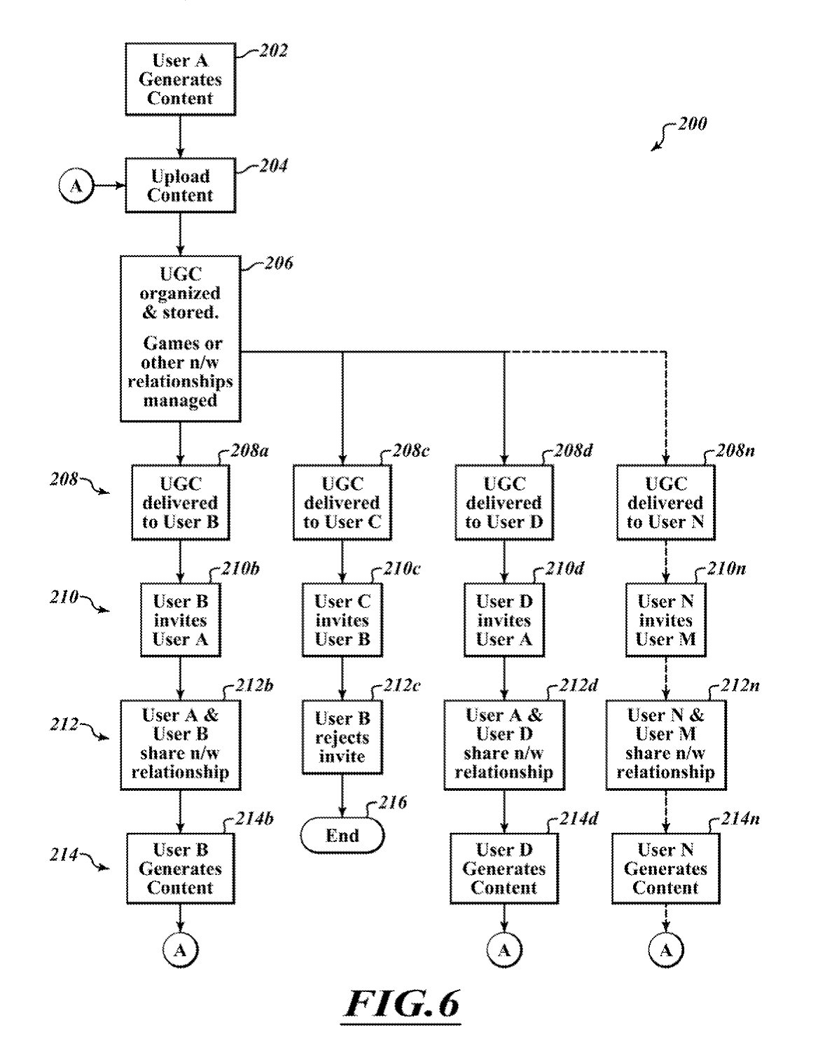

FIG. 6 is a program flow embodiment 200 illustrating interactive communications between a plurality of game playing pairs. The program flow 200 may be executed in the context of a the representative environment in FIG. 4, which incorporates devices that produce and act on invitations to participate based on user generated content.

At 202, User A creates user generated content (UGC). At 204, the UGC is uploaded or otherwise stored on a computing device such as computing server 112. Operations within a computing server 112 are carried out at 206. The operations at 206 include organizing and storing the uploaded UGC. The organization may include categorization of the UGC by a human administrators or programmatic operations related to the computing server 112. Creators of the UGC may also participate in the organization and categorization processes. Additionally other users registered with the computing server 112 (i.e., users having a stored personal profile) may also participate in the organization and categorization processes.

The operations of the computing server 112 may also include administering gaming sessions between two or more registered users. The computing servers also manage network relationships between users. For example, the computing server may facilitate communication links between users by processing requests to communicate electronic invitations to participate in interactive relationships based on user generated content.

At 208 UGC is delivered to certain computing devices. At 208b, UGC is delivered to User B. At 208c, UGC is delivered to User C. At 208d, UGC is delivered to User D. At 208n, UGC is delivered to User N. The dashed line connecting the operations at 208n and similar actions in the program flow associated with User N indicates that the computing server 112 may administer relationships between a few devices or a great number of devices.

Users are presented with the delivered UGC and based on the UGC, a particular first user invites a particular second user to participate in an interactive relationship at 210. The invitation to participate in the interactive relationship is facilitated via electronic invitations described herein. A single user can participate in one interactive relationship, no interactive relationships, or many interactive relationships. At 210b, User B invites User A to participate in an interactive relationship. At 210c, User C invites User B to participate in an interactive relationship. At 210d, User D invites User A to participate in an interactive relationship. At 210n, User N invites User M to participate in an interactive relationship.

In the program flow 200 of FIG. 6, at 212, particular users take action based on electronic invitations. At 212b, User A accepts the electronic invitation and User A and User B share an interactive network relationship. At 212c, User B rejects the electronic invitation. At 212d, User A accepts the electronic invitation and User A and User D share an interactive network relationship. User A is participating in two interactive relationships; one with User B and another with User D. At 212n, User M accepts the electronic invitation and User N and User M share an interactive network relationship.

At 214, users continue to create user generated content (UGC) and program flow passes back to “A.” Within the interactive network relationship, both users can create UGC that is uploaded to the computing server 112. At 214b, User B creates UGC. At 214d, User D creates UGC. At 214n, User N creates UGC. With respect to User C, the electronic invitation that was rejected by User B leads to an end of program flow for User C 216.

The electronic invitations that are communicated based on a user's review of user generated content is generally described herein with respect to turn-based games with two participants. It is recognized that the teaching in the present disclosure may also be applied to other games that are turn-based and other games that are not turn-based. Furthermore, it is recognized that the teaching in the present disclosure may be applied to non-gaming interactive relationships. Further still, it is recognized that interactive relationships described in the disclosure may include more than two participants. In fact, three, four, and even many users can participate in a single interactive relationship.

In the foregoing description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with electronic and computing systems including client and server computing systems, as well as networks have not been shown or described in detail to avoid unnecessarily obscuring descriptions of the embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

Unless the context requires otherwise, throughout the specification and claims which follow, the word “comprise” and variations thereof, such as, “comprises” and “comprising” are to be construed in an open, inclusive sense, e.g., “including, but not limited to,” indicating that the referenced elements, components, or steps may be present, or utilized, or combined with other elements, components, or acts that are not expressly referenced.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A non-transitory computer readable medium comprising content that causes operations on a computing device, the operations including:
forming an electronic communication link with a first computing server;
presenting via a user interface a plurality of video clips received from the first computing server, each presented video clip including information associated with a user who generated the presented video clip;
accepting input from a first user associated with the computing device, the input identifying a video clip selected from amongst the plurality of presented video clips;
requesting communication of an electronic invitation directed to a second user who generated the selected video clip, the electronic invitation inviting the second user who generated the selected video clip to participate in an interactive relationship with the first user via the first computing server; and
receiving an indication that the electronic invitation was accepted by the second user who generated the selected video clip.

2. The non-transitory computer readable medium of claim 1 comprising content that causes operations on a computing device wherein the interactive relationship via the first computing server includes participating in a computer-based game.

3. The non-transitory computer readable medium of claim 2 comprising content that causes operations on a computing device, the operations further including:
accepting gaming control input from the first user associated with the computing device, the gaming control input associated with taking a turn in the computer-based game.

4. The non-transitory computer readable medium of claim 3 comprising content that causes operations on a computing device, the operations further including:
presenting, via the user interface, information related to a turn in the computer-based game played by the second user who generated the selected video clip.

5. The non-transitory computer readable medium of claim 1 comprising content that causes operations on a computing device, the operations further including:
accepting video clip rating input from the first user associated with the computing device, the video clip rating input associated with an opinion of at least one video clip of the plurality of video clips received from the first computing server.

6. A method to form an interactive network relationship, comprising:
presenting user generated content via a computing device, the user generated content including information associated with a source of the user generated content;
after the presentation, generating an electronic invitation directed to the source of the user generated content, the electronic invitation including the information associated with the source of the user generated content; and
communicating the electronic invitation to the source of the user generated content.

7. The method to form an interactive network relationship of claim 6, comprising:
receiving an indication via the computing device that the electronic invitation has been accepted.

8. The method to form an interactive network relationship of claim 7, comprising:
initiating a turn-based game, the turn based game including at least two participants, a first participant being a user of the computing device and a second user being a user who accepted the electronic invitation.

9. The method to form an interactive network relationship of claim 6 wherein the user generated content includes at least one of an image, a video segment, an audio segment, an audio/video segment, or a group of words.

10. The method to form an interactive network relationship of claim 6 wherein presenting user generated content comprises:
presenting a plurality of user generated segments via the computing device, each one of the user generated segments including information associated with a source of the user generated segment, wherein the generated electronic invitation includes information associated with a selected one of the user generated segments.

11. The method to form an interactive network relationship of claim 10 wherein at least one of the user generated segments is an audio segment, a video segment, or an audio/video segment.

12. The method to form an interactive network relationship of claim 11 wherein at least one of the user generated segments is an image.

13. The method to form an interactive network relationship of claim 10 wherein at least one of the user generated segments is a plurality of words of text.

14. The method to form an interactive network relationship of claim 10 wherein each one of the plurality of user generated segments is presented in 5 seconds or less.

15. A non-transitory computer readable medium comprising content that causes operations on a computing server, the operations including:
forming an electronic communication link with a first computing device;
communicating a plurality of user generated content segments to the first computing device, each segment of the plurality including first information associated with a source of the respective user generated content segment;
selecting, based on second information received from the first computing device, one of the plurality of user generated content segments;
generating an electronic invitation directed to the source of the selected one of the plurality of user generated content segments, the electronic invitation including the first information associated with the source of the user generated content segment;
forming an electronic communication link with a second computing device, the second computing device associated with the source of the user generated content segment; and
communicating the electronic invitation to the second computing device.

16. The non-transitory computer readable medium of claim 15 comprising content that causes operations on a computing server, the operations further including:
receiving an indication via the second computing device that the electronic invitation has been accepted.

17. The non-transitory computer readable medium of claim 16 comprising content that causes operations on a computing server, the operations further including:
initiating a computer-based game, the computer-based game including at least two participants, a first participant being a user of the first computing device and a second user being a user of the second computing device.

18. The non-transitory computer readable medium of claim 17 comprising content that causes operations on a computing server, the operations further including:
communicating a second plurality of user generated content segments to the first computing device, each segment of the second plurality including third information associated with a source of the respective user generated content segment;
selecting, based on fourth information received from the first computing device, one of the second plurality of user generated content segments;
generating a second electronic invitation directed to the source of the selected one of the second plurality of user generated content segments, the second electronic invitation including the third information associated with the source of the user generated content segment;
forming an electronic communication link with a third computing device, the third computing device associated with the source of the user generated content segment; and
communicating the second electronic invitation to the third computing device.

19. The non-transitory computer readable medium of claim 17 comprising content that causes operations on a computing server, the operations further including:
receiving a user-generated rating from the first computing device, the rating associated with at least one segment of the plurality of user generated content segments.

20. The non-transitory computer readable medium of claim 15 comprising content that causes operations on a computing server wherein the first computing device is a handheld computing device.
